(19) United States
(12) Patent Application Publication
(10) Pub. No.: US 2016/0311933 A1
(43) Pub. Date: Oct. 27, 2016

(54) PROCESS FOR THE PREPARATION OF THIOL FUNCTIONALIZED HYDROXYALKYL STARCH DERIVATIVES

(71) Applicant: FRESENIUS KABI DEUTSCHLAND GMBH, Bad Homburg (DE)

(72) Inventors: Norbert ZANDER, Bad Nauheim (DE); Sabrina HUMMEL, Gelnhausen (DE); Dominik HECKMANN, Friedberg (DE); Franziska HAUSCHILD, Nidda (DE)

(21) Appl. No.: 14/777,890

(22) PCT Filed: Mar. 20, 2014
(86) PCT No.: PCT/EP2014/055597

§ 371 Date: Sep. 17, 2015

(30) Foreign Application Priority Data
Mar. 20, 2013 (EP) 13160264.1

(51) Int. Cl. C08B 31/12

(52) U.S. Cl. CPC C08B 31/12

(57) ABSTRACT

A process for the preparation of a thiol functionalized hydroxyalkyl starch derivative comprising (i) providing a reaction mixture comprising a solvent, hydroxyalkyl starch, cysteamine and/or cystamine, and a reductive amination agent; (ii) subjecting the reaction mixture provided in (i) to reductive amination conditions, and (iii) subjecting the mixture obtained from (ii) to reducing conditions.

The present invention relates to a process for the preparation of a thiol functionalized hydroxyalkyl starch derivatives which process results in a very high reactive thiol group content of the hydroxyalkyl starch derivative.

Hydroxyalkyl starch (HAS), in particular hydroxyethyl starch (HES), is a substituted derivative of the naturally occurring carbohydrate polymer amylopectin which is present in corn starch at a concentration of up to 95% by weight, and is degraded by alpha amylases in the body. HES in particular exhibits advantageous biological properties and is used as a blood volume replacement agent and in hemodilution therapy in clinics. Amylopectin consists of glucose moieties, wherein in the main chain alpha-1,4-glycosidic bonds are present and at the branching sites alpha-1,6-glycosidic bonds are found. The physicochemical properties of this molecule are mainly determined by the type of glycosidic bonds. Due to the nicked alpha-1,4-glycosidic bond, helical structures with about six glucose-monomers per turn are produced. The physicochemical as well as the biochemical properties of the polymer can be modified via substitution. The introduction of a hydroxyethyl group can be achieved via alkaline hydroxyethylation. By adapting the reaction conditions it is possible to exploit the different reactivity of the respective hydroxyl group in the unsubstituted glucose monomer with respect to a hydroxyethylation. Owing to this fact, the skilled person is able to influence the substitution pattern to a limited extent.

It is generally accepted that the stability of polypeptides can be improved and the immune response against polypeptides can be reduced if the polypeptides are coupled to hydroxyalkyl starch by forming a conjugate of the polypeptide with the hydroxyalkyl starch. One possible way of forming such a conjugate is coupling a hydroxyalkyl starch derivative to a thiol group of the polypeptide. For this purpose, it is necessary to prepare, starting from hydroxyalkyl starch, said hydroxyalkyl starch derivative which has the suitable chemical functionalities allowing the coupling to a thiol group of a polypeptide. Regarding these chemical functionalities, the functional groups Hal-CH₂—C(═O)— and H₂C═CH—S(═O)₂— may be mentioned by way of example.

For the preparation of these hydroxyalkyl starch derivatives, a preferred method comprises the preparation of a first hydroxyalkyl starch derivative in a first reaction which is then further derivatized to the hydroxyalkyl starch derivative to be coupled to a thiol group of the polypeptide. This first hydroxyalkyl starch derivative in turn is preferably a thiol functionalized hydroxyalkyl starch derivative, a hydroxyalkyl starch derivative which contains a thiol group which can be readily coupled, for example, to a linker compound which comprises a functional group which is coupled to the thiol group of the thiol functionalized hydroxyalkyl starch derivative, and which comprises a further functional group which can be coupled, for example, to a thiol group. Alternatively, the thiol functionalized hydroxyalkyl starch derivative can be used directly for the coupling to a biologically active compound.

Generally, a thiol functionalized hydroxyalkyl starch derivative may comprise several thiol groups, depending on the derivatization method applied. A preferred way of derivatizing hydroxyalkyl starch includes the use of the reducing end of the hydroxyalkyl starch molecule which, since being present in the hydroxyalkyl starch molecule exactly once, allows the preparation of monothiol functionalized hydroxyalkyl starch, and thus a hydroxyalkyl starch exhibiting an extremely well-defined thiol derivatization compared, for example, with a thiol derivatization strategy which is based on the derivatization of the hydroxyl groups of the hydroxyalkyl starch molecule or on the derivatization of aldehyde groups obtained by ring opening reactions of the monomeric units of the hydroxyalkyl starch molecule.

Therefore, there is a need for advantageous processes for the preparation of a thiol functionalized hydroxyalkyl starch, in particular the preparation of a monothiol functionalized hydroxyalkyl starch via the reducing end of the hydroxyalkyl starch.

EP 1 398 322 A1 discloses a method for the preparation of a thiol functionalized hydroxyethyl starch derivative wherein hydroxyethyl starch is derivatized at its reducing end with cysteamine free base. Although not disclosed in the respective example 13.4, a reactive thiol group content of the hydroxyethyl starch of about 4% or 9% was achieved, depending on which temperature and reaction period conditions were chosen.

A. Pawlowski et al., Vaccine 17 (1999) pp 1474-1483 discloses the preparation of a thiol functionalized dextran. A dextran molecule significantly differs from a hydroxyalkyl starch molecule since it completely lacks hydroxyalkyl groups, and this difference certainly has an impact on the chemical and physical characteristics of the molecule. In example 2.6 of this article, it is described that dextran is thiol functionalized in a three-step process wherein in a first step, the dextran is admixed with cystamine dihydrochloride at a specific pH, wherein in a second step, the pH has to be adjusted at another value by adding sodium hydroxide when sodium cyanoborohydride is added. In a third step, the —S—S— bonds, present due to the use of cystamine as reducing agent, are reduced. Regarding the third step, no reaction conditions are disclosed.

Surprisingly, it was found that for the thiol functionalization of hydroxyalkyl starch, a novel and advantageous process can be provided which, compared to the known thiol functionalization of hydroxyalkyl starch, results in a significantly improved reactive thiol group content. According to this process, the hydroxyalkyl starch is subjected to reductive amination conditions and, in a second step, subjected to reducing conditions.

Therefore, the present invention relates to a process for the preparation of a thiol functionalized hydroxyalkyl starch derivative comprising
(i) providing a reaction mixture comprising a solvent and hydroxyalkyl starch of formula (Ia)

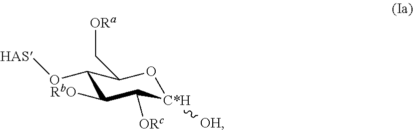

a compound of formula (Ib)

H₂N—CH₂—CH₂—S(—S—CH₂—CH₂—NH)ₓ—H (Ib)
wherein x=0 or 1,
and a reductive amination agent;
(ii) subjecting the reaction mixture provided in (i) to reductive amination conditions, obtaining, optionally after purification, a mixture comprising a thiol functionalized hydroxyalkyl starch derivative of formula (IIa)

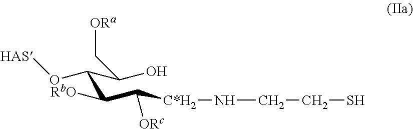

and/or a thiol functionalized hydroxyalkyl starch derivative of formula (IIb)

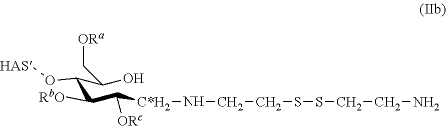

(iii) subjecting the mixture obtained from (ii) to reducing conditions, obtaining, optionally after purification, a mixture comprising the thiol functionalized hydroxyalkyl starch derivative of formula (IIa);
   wherein
   C* is the carbon atom of the reducing end of the hydroxyalkyl starch;
   R^{b} and R^{c} are —[(CR¹R²)ₘO]ₙ—H and are the same or different from each other;
   R^{a} is —[(CR¹R²)ₘO]ₙ—H with HAS′ being the remainder of the hydroxyalkyl starch molecule,
   or R^{a} is HAS″ with HAS′ and HAS″ together being the remainder of the hydroxyalkyl starch molecule;
   R¹ and R² are independently hydrogen or an alkyl group having from 1 to 4 carbon atoms, m is 2 to 4, wherein R¹ and R² are the same or different from each other in the m groups CR¹R²;
   n is from 0 to 6.

### The Hydroxyalkyl Starch

Hydroxyalkyl starch is an ether derivative of optionally partially hydrolyzed native starches wherein hydroxyl groups of the starch are suitably hydroxyalkylated. As hydroxyalkyl starches, hydroxypropyl starch and hydroxyethyl starch are preferred, with hydroxyethyl starch being most preferred.

Starch is a well-known polysaccharide according to formula (C₆H₁₀O₅)ₙ which essentially consists of alpha-D glucose units which are coupled via glycosidic linkages. Usually, starch essentially consists of amylose and amylopectin. Amylose consists of linear chains wherein the glucose units are linked via alpha-1,4-glycosidic linkages. Amylopectin is a highly branched structure with alpha-1,4-glycosidic linkages and alpha-1,6-glycosidic linkages. Native starches from which hydroxyalkyl starches can be prepared include, but are not limited to, cereal starches and potato starches. Cereal starches include, but are not limited to, rice starches, wheat starches such as einkorn starches, spelt starches, soft wheat starches, emmer starches, durum wheat starches, or kamut starches, corn starches, rye starches, oat starches, barley starches, triticale starches, spelt starches, and millet starches such as sorghum starches or teff starches. Preferred native starches from which hydroxyalkyl starches are prepared have a high content of amylopectin relative to amylose. The amylopectin content of these starches is, for example, at least 70% by weight, preferably at least 75% by weight, more preferably at least 80% by weight, more preferably at least 85% by weight, more preferably at least 90% by weight such as up to 95% by weight, up to 96% by weight, up to 97% by weight, up to 98% by weight, up to 99% by weight, or up to 100% by weight. Native starches having an especially high amylopectin content are, for example, suitable potato starches such as waxy potato starches which are preferably extracted from essentially amylose-free potatoes which are either traditionally bred (for example the natural variety Eliane) or genetically modified amylopectin potato varieties, and starches of waxy varieties of cereals such as waxy corn or waxy rice.

A preferred hydroxyalkyl starch of the present invention has a constitution according to formula (Ia)

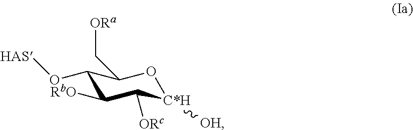

wherein HAS′ is the remainder of the hydroxyalkyl starch molecule, namely wherein HAS′ together with the explicitly shown ring structure, the terminal carbohydrate moiety at the reducing end of the hydroxyalkyl starch molecule, forms the hydroxyalkyl starch (HAS) molecule, and wherein
C* is the carbon atom of the reducing end of the hydroxyalkyl starch;
R^{b} and R^{c} are —[(CR¹R²)ₘO]ₙ—H and are the same or different from each other;
R^{a} is —[(CR¹R²)ₘO]ₙ—H with HAS′ being the remainder of the hydroxyalkyl starch molecule,
or R^{a} is HAS″ with HAS′ and HAS″ together being the remainder of the hydroxyalkyl starch molecule;
R¹ and R² are independently hydrogen or an alkyl group having from 1 to 4 carbon atoms,
m is 2 to 4, wherein R¹ and R² are the same or different from each other in the m groups CR¹R²;
n is from 0 to 6.

If R^{a} is HAS″, the hydroxyalkyl starch molecule has a branching site at the C6 position of the reducing end.

Preferably, R¹ and R² are the same or different and selected from the group consisting of H and methyl. More preferably, R¹ and R² are H. The integer m is 2 to 4, namely 2, 3, or 4. Preferably, m is 2. The integer n is 0 to 6, namely 0, 1, 2, 3, 4, 5 or 6, more preferably 0, 1, 2 or 3, more preferably 0, 1, or 2. More preferably n is 0.

According to the present invention, the hydroxyalkyl starch is hydroxyethyl starch, also referred to herein as HES. In this case, R¹ and R² are hydrogen, m is 2, n is 0 to 6, namely 0, 1, 2, 3, 4, 5, or 6, and R^{a}, R^{b}, R^{c} are the same or different from each other. Preferably, R^{b} and R^{c} are —[(CR¹R²)ₘO]ₙ—H and R^{a} is —[(CR¹R²)ₘO]ₙ—H with HAS′ being the remainder of the hydroxyalkyl starch molecule, or R^{a} is HAS″ with HAS′ and HAS″ together being the remainder of the hydroxyalkyl starch molecule, with n being 0 to 6, namely 0, 1, 2, 3, 4, 5 or 6, wherein in each group R^{a}, R^{b}, R^{c}, and n are the same or different from each other.

In formula (Ia) the reducing end of the hydroxyalkyl starch molecule is shown in the non-oxidized form and the terminal carbohydrate moiety of the hydroxyalkyl starch molecule is shown in the hemiacetal form which depending on for example the solvent, may be in equilibrium with the (free) aldehyde form.

The term “hydroxyalkyl starch” as used in the context of the present invention is not limited to compounds where the terminal carbohydrate moiety comprises groups R^{a} either being HAS″ or —[(CR¹R²)ₘO]ₙ—H and R^{b} and R^{c} being —[(CR¹R²)ₘO]ₙ—H as shown, for the sake of brevity, in formula (Ia), but generally refers to compounds in which at least one hydroxyl group which is present anywhere in the hydroxyalkyl starch, either in the terminal saccharide unit of the hydroxyalkyl starch molecule and/or in the remainder of the hydroxyalkyl starch molecule, HAS′, is substituted by the group —[(CR¹R²)ₘO]ₙ—H. The hydroxyalkyl starch may further contain one or more hydroxyalkyl groups, which comprise more than one hydroxyl group, in particular two or more hydroxyl groups. Preferably, the hydroxyalkyl groups comprised in the hydroxyalkyl starch contain one hydroxyl group only. According to the present invention, hydroxyalkyl starch according to above-mentioned formula (Ia) is preferably employed. The other carbohydrate moieties comprised in HAS′ may be the same as or different from the explicitly described saccharide ring, with the difference that they lack a reducing end.

Hydroxyalkyl starch is mainly characterized by the molecular weight distribution, the degree of substitution and the ratio of C2/C6 substitution.

There are two possibilities of describing the substitution degree. The degree of substitution (DS) of hydroxyalkyl starch is described relatively to the portion of substituted glucose monomers with respect to all glucose moieties. The substitution pattern of hydroxyalkyl starch can also be described as the molar substitution (MS), wherein the number of hydroxyalkyl groups per glucose moiety is counted. In the context of the present invention, the substitution pattern of hydroxyalkyl starch is described in terms of MS. Regarding MS, reference is also made to Sommermeyer et al., 1987, Krankenhauspharmazie, 8(8), 271-278, in particular p. 273. MS is determined by gas chromatography after total hydrolysis of the hydroxyalkyl starch. MS values of the respective hydroxyalkyl starch starting material are given. It is assumed that the MS value is not affected during the method according to the present invention.

Hydroxyalkyl starch is present as polydisperse compositions, wherein each molecule differs from the other with respect to the polymerization degree, the number and pattern of branching sites, and the substitution pattern. Hydroxyalkyl starch is therefore a mixture of compounds with different molecular weight.

Consequently, a particular hydroxyalkyl starch solution is determined by the average molecular weight with the help of statistical means. In this context, Mₙ or Mn is calculated as the arithmetic mean depending on the number of molecules and their molecular weight. The number average molecular weight Mₙ is defined by the following equation:

Mₙ=ΣᵢnᵢMᵢ/Σᵢnᵢ

wherein nᵢ is the number of hydroxyalkyl starch molecules of species i having molar mass Mᵢ. Alternatively, the mass distribution can be described by the weight average molecular weight M_{w} or Mw. The weight average molecular M_{w} weight is defined by the following equation:

M_{w}=ΣᵢnᵢMᵢ²/ΣᵢnᵢMᵢ

wherein nᵢ is the number of hydroxyalkyl starch molecules of species i having molar mass Mᵢ. According to the present invention, M_{w} values are preferably in the range of from 1 to 2000 kDa, more preferably of from 5 to 700 kDa, more preferably of from 10 to 300 kDa, more preferably of from 70 to 150 kDa.

The second parameter which is usually referred to as MS (molecular substitution) describes the number of hydroxyalkylated sites per anhydroglucose unit of a given hydroxyalkyl starch (Sommermeyer et al., Krankenhauspharmazie 8 (8), 1987, pp 271-278, in particular page 273). The values of MS correspond to the degradability of the hydroxyalkyl starch by alpha-amylase. Generally, the higher the MS value of the hydroxyalkyl starch, the lower is its respective degradability. The parameter MS can be determined according to Ying-Che Lee et al., Anal. Chem. 55, 1983, pp 334-338; or K. L. Hodges et al., Anal. Chem. 51, 1979, p 2171. According to these methods, a known amount of the hydroxyalkyl starch is subjected to ether cleavage in xylene whereby adipinic acid and hydriodic acid are added. The amount of released iodoalkane is subsequently determined via gas chromatography using toluene as an internal standard and iodoalkane calibration solutions as external standards. According to the present invention, MS values are preferably in the range of from 0.1 to 3, more preferably from 0.2 to 1.3, more preferable from 0.4 to 1.1.

The third parameter which is referred to as “C2/C6 ratio” describes the ratio of the number of the anhydroglucose units being substituted in C2 position relative to the number of the anhydroglucose units being substituted in C6 position. During the preparation of the hydroxyalkyl starch, the C2/C6 ratio can be influenced via the pH used for the hydroxyalkylation reaction. Generally, the higher the pH, the more hydroxyl groups in C6 position are hydroxyalkylated. The parameter C2/C6 ratio can be determined, for example, according to Sommermeyer et al., Krankenhauspharmazie 8 (8), 1987, pp 271-278, in particular page 273. According to the present invention, typical values of the C2/C6 ratio are in the range of from 2 to 20, preferably of from 2 to 15, more preferably of from 2 to 12.

According to the present invention, the compound of formula a preferred embodiment the compound according to formula (Ib) is preferably selectively reacted via the carbon atom C* of the reducing end of the hydroxyalkyl starch, i.e. with the reducing end of the hydroxyalkyl starch. The term “selectively reacted with the reducing end” relates to processes according to which a least 95%, more preferably at least 98%, more preferably at least 99%, more preferably at least 99.5%, more preferably at least 99.9% of all reacted hydroxyalkyl starch molecules are exclusively reacted via the reducing end group. Accordingly, the hydroxyalkyl starch is reacted via its non-oxidized reducing end with the compound of formula (Ib), in particular with the amino group of the compound of formula (Ib).

### Step (i)

According to step (i) of the process of the present invention, a reaction mixture is provided which comprises a solvent and hydroxyalkyl starch of formula (Ia)

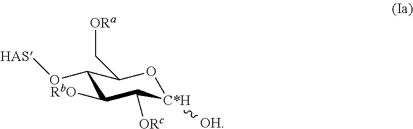

Regarding the solvent, no specific restrictions exist provided that the reductive amination reaction according to step (i) can be carried out. Preferably, the solvent is a polar solvent or a mixture of two or more polar solvents. More preferably, the solvent is selected from the group consisting of water, dimethylformamide, dimethylacetamide, N-methyl pyrrolidinone, formamide, dimethylsulfoxide, acetic acid, and a mixture of two or more thereof. Further, it is conceivable that the solvent comprises an aqueous buffer. More preferably, the solvent comprises water. More preferably, the solvent is water. Therefore, it is preferred that in step (i), an aqueous reaction mixture is provided which comprises hydroxyalkyl starch of formula (Ia).

Further in step (i), the mixture comprises a compound of formula (Ib)

H₂N—CH₂—CH₂—S(—S—CH₂—CH₂—NH)ₓ—H (Ib)

wherein x=0 or 1. Therefore, the compound used as reductive amination reagent is either either cysteamine, H₂N—CH₂—CH₂—SH, or cystamine, H₂N—CH₂—CH₂—S—S—CH₂—CH₂—NH₂. Cystamine and cysteamine can be employed either as free base, or as suitable salt, or as a mixture of the free base and at least one suitable salt. Further, it is conceivable that both cystamine and cysteamine are employed, each of them either as free base, or as suitable salt, or as a mixture of the free base and at least one suitable salt. Preferably, cystamine and cysteamine are employed as salt. Regarding these suitable salts, all salts are conceivable which allow the reductive amination according to (ii). Suitable salts include, but are not restricted to, inorganic salts, preferably water-soluble inorganic salts, such as hydrobromide, hydrochloride, sulfate, hydrogen sulfate, phosphate, hydrogen phosphate, dihydrogen phosphate, carbonate, or hydrogen carbonate. Preferably, the salt is hydrochloride. Therefore, the present invention relates to the process as described above, wherein in (i), the compound of formula (Ib) is employed as a salt, preferably as hydrochloride if x is 0 or as dihydrochloride if x=1. Preferably, cysteamine is employed in (i), more preferably a cysteamine salt, more preferably cysteamine hydrochloride.

Further in step (i), the mixture comprises a reductive amination agent. Preferably, the reductive amination agent is selected from the group consisting of sodium cyanoborohydride, sodium triacetoxy borohydride, sodium borohydride, organic borane complex compounds such as a 4-(dimethylamino)pyridine borane complex, N-ethyldiisopropylamine borane complex, N-ethylmorpholine borane complex, N-methylmorpholine borane complex, N-phenylmorpholine borane complex, lutidine borane complex, triethylamine borane complex, trimethylamine borane complex, and a combination of two or more thereof. More preferably, in (i), the reductive amination agent, preferably the sole reductive amination agent, is sodium cyanoborohydride of formula (Ic)

NaCNBH₄ (Ic).

Regarding the concentration of the compounds comprised in the mixture provided in (i), no specific restrictions exist provided that the reductive amination reaction can be carried out.

Preferably, the reaction mixture provided in (i) comprises the hydroxyalkyl starch at a concentration of at least 1 weight-%, preferably at least 5 weight-%, more preferably at least 10% weight-%. More preferably, the reaction mixture provided in (i) comprises the hydroxyalkyl starch at a concentration in the range of from 10 to 50 weight-%, more preferably from 15 to 45 weight-%, more preferably from 20 to 40 weight-% such as from 20 to 30 weight-% or from 25 to 35 weight-% or from 30 to 40 weight-%.

Preferably, the reaction mixture provided in (i) comprises the compound of formula (Ib) at a concentration in the range of from 0.05 to 3 mol/l, more preferably from 0.1 to 2.5 mol/l, more preferably from 0.2 to 2 mol/l, more preferably from 0.5 to 2 mol/l. In particular, of the compound of formula (Ib) is cysteamine, the reaction mixture provided in (i) comprises the compound of formula (Ib) preferably at a concentration in the range of from 0.7 to 2 mol/l, more preferably from 0.9 to 2 mol/l. If the compound of formula (Ib) is cystamine, the reaction mixture provided in (i) comprises the compound of formula (Ib) preferably at a concentration in the range of from 0.3 to 1.5 mol/l, more preferably from 0.5 to 1.25 mol/l.

Preferably, the reaction mixture provided in (i) comprises the reductive amination agent, preferably the sodium cyanoborohydride of formula (Ic), at a concentration in the range of from 0.05 to 2 mol/l, more preferably from 0.1 to 1 mol/l, more preferably from 0.2 to 0.8 mol/l, more preferably from 0.3 to 0.6 mol/l.

Generally, it is possible that the solvent comprised in the reaction mixture provided in (i), preferably water, comprises a buffer, preferably an aqueous buffer. Possible buffers include, but are not restricted to buffers of a pH in the range of from 5 to 8 such as suitable acetate buffers like a 0.6-3 M acetate buffer or phosphate buffers like a 0.6 M phosphate buffer. Preferably, the solvent comprised in the reaction mixture provided in (i), preferably water, does not comprise a buffer. More preferably, the reaction mixture provided in (i) does not comprise an acetate buffer and does not comprise a phosphate buffer.

Generally, when providing the reaction mixture according to (i), the sequence of mixing the components of the reaction mixture is not subjected to specific restrictions. Preferably, the hydroxyalkyl starch is first admixed with at least a portion of the solvent, and to the resulting mixture, the compound of formula (Ib) is added which, for example, can be employed as mixture with at least a portion of the solvent. Preferably, the reductive amination agent as added to the mixture containing the hydroxyalkyl starch and the compound of formula (Ib). The temperature of the mixture during the mixing of the individual components for providing the reaction mixture in (i) can be suitably chosen. Preferably, during the mixing, the mixture is brought to and kept at the temperature at which the reductive amination reaction in (ii) is carried out. Therefore, during the mixing in (i), it is preferred to adjust the temperature of the mixture to a value in the range of from 40 to 80° C., preferably from 45 to 75° C., more preferably from 55 to 65° C. During providing the reaction mixture in (i), the mixture can be suitably stirred.

According to the present invention, the reaction mixture provided in (i) preferably does not contain sodium hydroxide, more preferably does not contain an inorganic base. More preferably, during (i) and (ii), the pH of the reaction mixture is not adjusted, neither by adding a buffer nor by adding an acid or a base in addition to the solvent and the compounds of formulas (Ia), (Ib), and the reductive amination agent. Therefore, compared to the multistep process described in A. Pawlowski et al., the process according to the present invention, the process of the present invention is preferably characterized in that fewer components of the reductive amination reaction mixture have to be employed and that fewer steps have to be realized in the course of the reductive amination reaction.

### Step (ii)

According to step (ii) of the process of the present invention, the reaction mixture provided in (i) is subjected to reductive amination conditions. Generally, this step (ii) starts when at least a portion of the reductive amination agent is added to a mixture of the compound of formula (Ia) and (Ib). Therefore, in this case, steps (i) and (ii) of the process of the present invention may partially overlap and may not be regarded as steps clearly separated from each other. This is the case in particular if the reaction mixture provided in (i) is prepared at a temperature of the reaction mixture being in the preferred ranges of step (ii).

During (ii), the temperature of the reaction mixture is suitably chosen. Generally, during (ii), the temperature of the reaction mixture is in the range of from 10 to 100° C. such as from 20 to 90° C. or from 40 to 80° C. Preferably, during (ii), the temperature of the reaction mixture is in the range of from 45 to 75° C., more preferably from 55 to 65° C. If the reaction mixture is provided in (i) at a temperature which is lower or higher than, preferably lower than the temperature according to (ii), step (ii) further comprises adjusting the temperature of the reaction mixture, preferably heating the reaction mixture to a temperature according to (ii) in the ranges mentioned above.

Subjecting the reaction mixture provided in (i) to the reductive amination conditions in (ii) can be carried out for any suitable time period. Generally, the time period is in the range of from 1 to 48 h such as from 2 to 36 h. Preferably, the time period is in the range of from 3 to 24 h, more preferably from 6 to 21 h, more preferably from 4 to 18 h.

Preferably, in (ii), subjecting the reaction mixture provided in (i) to reductive amination conditions comprises keeping the mixture at a temperature in the range of from 40 to 90° C. for a time period of from 1 to 36 h, more preferably at a temperature in the range of from 45 to 80° C. for a time period of from 2 h to 24 h, more preferably at a temperature in the range of from 55 to 65° C. for a time period of from 4 to 18 h.

After having finished the reductive amination reaction in (ii), it is conceivable that the reaction mixture obtained may be subjected to (iii). Preferably, the reaction mixture obtained is subjected to a suitable work-up before it is subjected to (iii). Therefore, the present invention relates to the process as described above, wherein (ii) comprises subjecting the reaction mixture provided in (i) to reductive amination conditions and working up the obtained mixture. Such working up may comprise one or more stages wherein preferably at least one stage comprises a purification, preferably a purification by ultrafiltration, precipitation, size exclusion chromatography, and a combination of two or more of these methods, more preferably by ultrafiltration. Optionally, such working up may comprise at least one stage which comprises a pH adjustment, preferably an adjustment to a pH of at least 8, preferably at least 9, more preferably in the range of from 9 to 11. Preferably, the present invention relates to the process as described above, wherein (ii) comprises
(a1) subjecting the reaction mixture provided in (i) to reductive amination conditions;
(b1) optionally adjusting the pH of the reaction mixture obtained from (a1) to a value of at least 8, preferably at least 9;
(c1) purifying the mixture obtained from (b1), preferably by ultrafiltration.

Adjusting the pH of the reaction mixture to a value of at least 8, preferably at least 9, more preferably from 9 to 11 can be realized, if carried out, according to all conceivable methods. Preferably, an inorganic base, preferably an alkali metal base and/or an alkaline earth metal base, more preferably an alkali metal hydroxide and/or an alkaline earth metal hydroxide, more preferably an alkaline metal hydroxide, more preferably sodium hydroxide is added in a suitable amount. The addition of such a basic compound can be performed at the temperature of the reaction mixture of the reductive amination reaction. Preferably, the reaction mixture obtained from the reductive amination reaction is cooled before the basic compound is added, preferably to a temperature in the range of from 10 to 35° C., more preferably from 20 to 30° C. During adding the basic compound, the mixture can be suitably stirred. The pH is to be understood as the value indicated by a pH sensitive glass electrode without correction.

The preferably applied ultrafiltration can be performed according to all suitable methods. Preferably, the ultrafiltration comprising at least one volume exchange with water, preferably at least five volume exchanges with water, more preferably at least 10 volume exchanges with water. According to an embodiment of the present invention, the ultrafiltration does not comprise a volume exchange with an acid. Preferably, the ultrafiltration does not comprise a volume exchange with a base. More preferably, the ultrafiltration does not comprise a volume exchange with an acid and does not comprise a volume exchange with a base. Preferably, the present invention relates to the process as described above, wherein (ii) comprises
(a1) subjecting the reaction mixture provided in (i) to reductive amination conditions;
(b1) optionally adjusting the pH of the reaction mixture obtained from (a1) to a value of at least 8, preferably at least 9, more preferably from 9 to 11;
(c1) purifying the mixture obtained from (b1), preferably by ultrafiltration, more preferably by ultrafiltration comprising at least one volume exchange with water.

After (c1), the purified mixture can be subjected directly, without any further intermediate stage, to (iii). It is also possible to freeze the purified mixture and subject it to (iii) after suitable unfreezing.

The mixture obtained from comprising the thiol functionalized hydroxyalkyl starch derivative of formula (IIa)

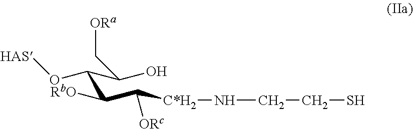

and/or a thiol functionalized hydroxyalkyl starch derivative of formula (IIb)

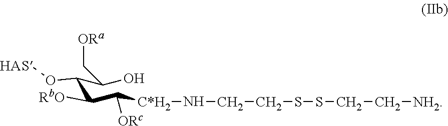

Step (iii)

According to step (iii) of the process of the present invention, the mixture obtained from (ii), preferably the purified mixture obtained from (ii), is subjected to conditions. From step (iii), a mixture is obtained which comprises the thiol functionalized hydroxyalkyl starch derivative of formula (IIa)

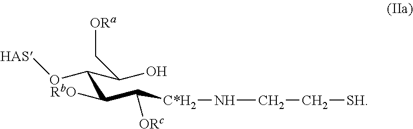

Preferably, the mixture obtained from (ii) is used as such, in particular in case the mixture obtained from (ii) is an aqueous mixture. Other solvents in (iii) are generally conceivable, with water being especially preferred. Further, the mixture according to (iii) may comprise a suitable organic solvent in addition to water such as dimethylformamide, dimethylacetamide, N-methyl pyrrolidinone, formamide, or acetic acid. Preferably, the mixture in (iii) contains only water as solvent. Further, the pH of the mixture may be adjusted to a pH of from 7 to 14, more preferably of from 9 to 14, most preferably of from 10 to 13. Adjustment of the pH may be achieved according to all conceivable methods. Preferably, an inorganic base, preferably an alkali metal base and/or an alkaline earth metal base, more preferably an alkali metal hydroxide and/or an alkaline earth metal hydroxide, more preferably an alkaline metal hydroxide, more preferably sodium hydroxide is added in a suitable amount. Alternatively, alkaline buffers such as phosphate buffers, borate buffer or carbonate buffers may be employed. Preferably, the pH is not adjusted prior to addition of sodium borohydride.

The reducing conditions applied in (iii) are realized by adding a suitable reducing agent to the mixture obtained from (ii). Preferred reducing agents include, but are not restricted to, borohydrides such as sodium borohydride, thiols such as dithioerythritol (DTT), phosphines such as tris(carboxyethyl)phosphine (TCEP), and combinations of two or more thereof. More preferably, sodium borohydride is added in (iii) as reducing agent, more preferably as the sole reducing agent.

Regarding the concentrations of the reducing agent in the mixture according to (iii) is concerned, no specific restrictions exist provided that the reducing reaction can be suitably carried out. Preferably, the mixture obtained from adding the reducing agent, preferably the sodium borohydride, comprises the reducing agent, preferably the sodium borohydride, at a concentration in the range of at least 0.02 mol/l, more preferably from 0.05 to 1 mol/l, more preferably from 0.1 to 0.5 mol/l. Therefore, the present invention also relates to the process as described above, wherein in (iii), sodium borohydride of formula (Id)

NaBH₄ (Id)

is added as reducing agent to the mixture obtained from (ii) and the mixture obtained from adding the sodium borohydride comprises the sodium borohydride preferably at a concentration in the range of from 0.05 to 1 mol/l, more preferably from 0.1 to 0.5 mol/l.

Preferably, in (iii), the mixture contains the hydroxyalkyl starch and the hydroxyalkyl starch derivative at a concentration in the range of from 1 to 40 weight-%, more preferably of from 5 to 30 wt. % and more preferably of from 10 to 20 weight % If the respective concentration with respect to the mixture obtained from (ii) is higher than these preferred concentrations, a suitable solvent such as a preferred solvent mentioned above, more preferably water, can be added.

Subjecting the mixture to the reducing conditions in (iii) can be carried out for any suitable time period. Generally, the time period is in the range of from 10 min to 24 h. Surprisingly, it was found that time periods of more than 4 hours may lead to a decrease in the number of reactive thiol groups. Without wanting to be bound by any theory, it is believed that this decrease may be based on the consumption of the reducing agent employed in (iii) and a re-oxidation after said consumption. Therefore, in order to further improve the process of the present invention, it is preferred that the mixture is subjected in (iii) to the reducing conditions for a time period of at most 4 h. Preferably, the time period is in the range of from 0.25 to 4 h, more preferably from 1 to 3 h.

The reduction reaction according to (iii) can be carried out at every suitable temperature. Preferably, the reduction reaction is carried out a temperature in the range of from 5 to 40° C., more preferably from 10 to 35° C., more preferably from 20 to 30° C. such as at room temperature.

Preferably, in (iii), subjecting the mixture to reducing conditions comprises keeping the mixture at a temperature in the range of from 10 to 35° C. for a period of from 0.25 to 4 h, more preferably at a temperature in the range of from 20 to 30° C. for a period of from 1 to 3 h.

During subjecting the mixture to reducing conditions (iii), the mixture may tend to foaming. Therefore, it is preferred that at least one anti-foaming agent is suitably added, either prior to and/or during subjecting the mixture to reducing conditions. Regarding the concentration and the chemical nature of the anti-foaming, no specific restrictions exist, provided that the reducing reaction can be carried out. Preferred anti-foaming agents include, but are not restricted to, alcohols such as methanol, ethanol, isopropanol, silicone oils such as polymethylsiloxanes or combinations of two or more thereof

During subjecting the mixture to reducing conditions (iii), the mixture, the mixture is preferably stirred.

After having finished the reducing reaction in (iii), it is conceivable that the mixture obtained may be subjected as starting material to a further process, for example as starting material in a process for the preparation of a conjugate and hydroxyalkyl starch as described hereinunder. Preferably, the mixture obtained is subjected to a suitable work-up before it is used as such a starting material. Therefore, the present invention relates to the process as described above, wherein (iii) comprises subjecting the mixture obtained from (ii) to reducing conditions and working up the obtained mixture. Such working up may comprise one or more stages wherein preferably at least one stage comprises a purification, preferably a purification by ultrafiltration, precipitation, size exclusion chromatography, and a combination of two or more of these methods, more preferably by ultrafiltration, and/or at least one stage comprises quenching, preferably a quenching with an acid. Preferably, the present invention relates to the process as described above, wherein (iii) comprises
(a2) subjecting the mixture to reducing conditions;
(b2) quenching the mixture obtained from (a2), preferably with an acid, obtaining an acidic solution;
(c2) purifying the mixture obtained from (b2), preferably by ultrafiltration;

Optionally, step (iii) may comprise lyophilizing the mixture, which lyophilizing is preferably carried out after (c2). Therefore, the process of the present invention optionally comprises
(d2) lyophilizing the mixture obtained as retentate from (c2).

Quenching the mixture can be realized according to all conceivable methods. Preferably, the acid which is used for quenching is selected from the group consisting of acetic acid, hydrochloric acid, sulfuric acid, citric acid, and a mixture of two or more thereof, the acid more preferably being acetic acid. The amount of acid used is suitably chosen so as to allow for quenching the residual reducing agent, preferably the sodium borohydride. Preferably, the pH value after quenching is in the range of from 1 to 7, more preferably from 2 to 6, more preferably from 3 to 5. Preferably, the quenching is carried out at a temperature in the range of from 10 to 35° C., more preferably from 20 to 30° C. During adding the acid, the mixture can be suitably stirred.

The preferably applied ultrafiltration can be performed according to all suitable methods. Preferably, the ultrafiltration comprises at least one volume exchange with an acidic buffer solution, more preferably at least 2 volume exchanges with an acidic buffer solution, more preferably at least 5 volume exchanges with an acidic buffer solution. Further, it is preferred that the ultrafiltration comprises at least one volume exchange with water, more preferably at least 2 volume exchanges with water. More preferably, the at least one volume exchange with water is performed after the at least one volume exchange with an acidic buffer solution. Preferably, the ultrafiltration does not comprise a volume exchange with a base. Preferred acidic buffer solutions have a pH in the range of from 3.5 to 5.5, more preferably from 4 to 5. Preferably, an acetate buffer is employed.

Preferably, an acidic buffer solution used in (iii) contains at least one ion chelating agent. Preferably, the ion chelating agent is selected from the group consisting of ethylenediaminetetraacetic acid (EDTA), diethylenetriaminepentaaceticacid (DTPA), and a combination thereof. Preferred concentrations of the ion chelating agent are in the range of from 1 to 20 mmol/l, more preferably from 2 to 10 mmol/l.

Therefore, the present invention also relates to the process as described above, wherein (iii) comprises
(a2) subjecting the mixture to reducing conditions;
(b2) quenching the mixture obtained from (a2), preferably with an acid, preferably selected from the group consisting of acetic acid, hydrochloric acid, sulfuric acid, citric acid, and a mixture of two or more thereof, more preferably with acetic acid, obtaining an acidic solution;
(c2) purifying the mixture obtained from (b2), preferably by ultrafiltration, more preferably by ultrafiltration comprising at least one volume exchange with an acidic buffer solution optionally comprising an ion chelating agent, and further comprising at least one volume exchange with water;
(d2) optionally lyophilizing the mixture obtained as retentate from (c2).

According to the process of the present invention, the reactive thiol group content of the thiol functionalized hydroxyalkyl starch derivative comprised in the mixture obtained from (iii), preferably from (c2) and optionally from (d2), is preferably at least 50%, more preferably at least 60%, more preferably at least 70%. More preferably, in particular in case cysteamine, preferably cysteamine hydrochloride is used as reductive amination reaction agent in (i), the reactive thiol group content of the thiol functionalized hydroxyalkyl starch derivative comprised in the mixture obtained from (iii) is at least 75%, more preferably in the range of from 75 to 90%. Therefore, compared to the prior art which teaches the thiol functionalization of hydroxyethyl starch and where only comparatively low reactive thiol group contents of less than 10% were achieved (reference is made to comparative example 1 hereinunder), the process according to the present invention allows to achieve significantly increased reactive thiol group contents.

A further advantage of the process of the present invention is to be seen in the fact the molecular weight of the thiol functionalized hydroxyalkyl starch derivative is only at most 10%, preferably only at most 5% higher than the molecular weight of the hydroxyalkyl starch starting material of formula (Ia). Therefore, compared to the prior art process for thiol functionalizing hydroxyalkyl starch, the process of the present invention leads to a considerable increase in the reactive thiol group content combined with an only moderate increase in the molecular weight of the thiol functionalized hydroxyalkyl starch derivative compared to the hydroxyalkyl starch starting material.

A preferred process of the present invention comprises
(i) providing an aqueous reaction mixture comprising hydroxyethyl starch of formula (Ia)

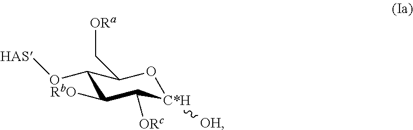

wherein C* is the carbon atom of the reducing end of the hydroxyalkyl starch, HAS′ is the remainder of the hydroxyethyl starch molecule and R^{a}, R^{b} and R^{c} are [(CR¹R²)ₘO]ₙ—H, R^{a}, R^{b} and R^{c} being the same or different from each other wherein R¹ and R² are hydrogen, m is 2, and n is 0 to 6;
the mixture further comprising the hydrochloride of the compound of formula (Ib)

H₂N—CH₂—CH₂—SH (Ib),
and sodium cyanoborohydride of formula (Ic)

NaBH₃CN (Ic);
(ii) (a1) subjecting the reaction mixture provided in (i) to reductive amination conditions;
   (b1) optionally adjusting the pH of the reaction mixture obtained from (a1) to a value from 9 to 11;
   (c1) purifying the mixture obtained from (b1) by ultrafiltration comprising at least one volume exchange with water;
   obtaining a mixture comprising a thiol functionalized hydroxyalkyl starch derivative of formula (IIa)

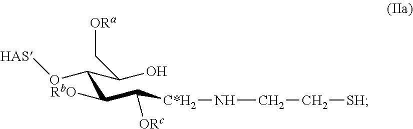

(iii) (a2) subjecting the mixture to reducing conditions at a temperature in the range of from 10 to 35° C. for a period of from 0.25 to 4 h wherein sodium borohydride of formula (Id)

NaBH₄ (Id)
is added as reducing agent to the mixture obtained from (ii);
(b2) quenching the mixture obtained from (a2), preferably with an acid, obtaining an acidic solution;
(c2) purifying the mixture obtained from (b2) by ultrafiltration comprising at least one volume exchange with an acidic buffer solution comprising an ion chelating agent, and further comprising at least one volume exchange with water;
(d2) optionally lyophilizing the mixture obtained as retentate from (c2);
obtaining a mixture comprising the thiol functionalized hydroxyalkyl starch derivative of formula (IIa) wherein the reactive thiol group content of the thiol functionalized hydroxyalkyl starch derivative is in the range of from 75 to 90%. Preferably, a mixture is obtained comprising the thiol functionalized hydroxyalkyl starch derivative of formula (IIa) wherein the reactive thiol group content of the thiol functionalized hydroxyalkyl starch derivative is in the range of from 75 to 90% and wherein the molecular weight of the thiol functionalized hydroxyalkyl starch derivative is at most 10%, preferably at most 5% higher than the molecular weight of the hydroxyalkyl starch starting material of formula (Ia).

Further, the present invention relates to a mixture, preferably an aqueous mixture, comprising a thiol functionalized hydroxyalkyl starch derivative of formula (IIa)

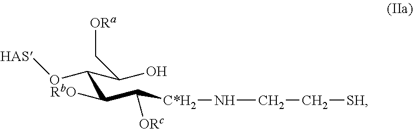

obtainable or obtained by the process of the present invention comprising steps (i), (ii) and (iii), wherein the reactive thiol group content of the thiol functionalized hydroxyalkyl starch derivative is preferably at least 50%, more preferably at least 70%, more preferably at least 75%, more preferably in the range of from 75 to 90%.

As mentioned above, the thiol functionalized hydroxyalkyl starch derivative of formula (IIa) which is obtainable or obtained by the process of the present invention comprising steps (i), (ii) and (iii), is preferably used for the preparation of a conjugate of hydroxyalkyl starch and a biologically active agent. Regarding the biologically active, no specific restrictions exist provided that it contains at least one functional group via which the thiol functionalized hydroxyalkyl starch derivative of formula (IIa) can be coupled, either directly via the thiol group of the thiol functionalized hydroxyalkyl starch derivative of formula (IIa) or via at least one linking compound which bridges the thiol functionalized hydroxyalkyl starch derivative of formula (IIa) and the biologically active agent. Preferred biologically active agents selected from the group consisting of a peptide, a polypeptide, an enzyme, a small molecule drug, a dye, a lipid, a nucleoside, a nucleotide, a nucleotide analog, an oligonucleotide, a nucleic acid analog, a cell, a virus, a liposome, a microparticle, and a micelle. Preferred methods of preparing such conjugates include, but are not restricted to,
reacting the thiol functionalized hydroxyalkyl starch derivative of formula (IIa) with a biologically active agent; or
reacting the thiol functionalized hydroxyalkyl starch derivative of formula (IIa) with an at least bifunctional linking compound and reacting the obtained product with a biologically active agent; or
reacting a biologically active agent with an at least bifunctional linking compound and reacting the obtained product with the thiol functionalized hydroxyalkyl starch derivative of formula (IIa); or
reacting the thiol functionalized hydroxyalkyl starch derivative of formula (IIa) with a first at least bifunctional linking compound obtaining a first product, reacting a biologically active agent with a second at least bifunctional linking compound obtaining a second product, and reacting the first with the second product.

Therefore, the present invention also relates to the use of a thiol functionalized hydroxyalkyl starch derivative of formula (IIa)

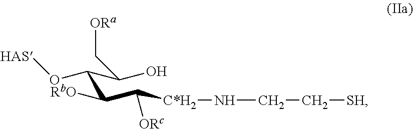

obtainable or obtained by the process of the present invention comprising steps (i), (ii) and (iii), for the preparation of a conjugate of hydroxyalkyl starch and a biologically active agent, preferably selected from the group consisting of a peptide, a polypeptide, an enzyme, a small molecule drug, a dye, a lipid, a nucleoside, a nucleotide, a nucleotide analog, an oligonucleotide, a nucleic acid analog, a cell, a virus, a liposome, a microparticle, and a micelle, wherein the preparation of the conjugate of hydroxyalkyl starch and a biologically active agent comprises
reacting the thiol functionalized hydroxyalkyl starch derivative of formula (IIa) with a biologically active agent; or
reacting the thiol functionalized hydroxyalkyl starch derivative of formula (IIa) with an at least bifunctional linking compound and reacting the obtained product with a biologically active agent; or
reacting a biologically active agent with an at least bifunctional linking compound and reacting the obtained product with the thiol functionalized hydroxyalkyl starch derivative of formula (IIa); or
reacting the thiol functionalized hydroxyalkyl starch derivative of formula (IIa) with a first at least bifunctional linking compound obtaining a first product, reacting a biologically active agent with a second at least bifunctional linking compound obtaining a second product, and reacting the first with the second product.

Further, the present invention relates to a process for the preparation of a conjugate of hydroxyalkyl starch and a biologically active agent, preferably selected from the group consisting of a peptide, a polypeptide, an enzyme, a small molecule drug, a dye, a lipid, a nucleoside, a nucleotide, a nucleotide analog, an oligonucleotide, a nucleic acid analog, a cell, a virus, a liposome, a microparticle, and a micelle, said process preferably comprising
reacting the thiol functionalized hydroxyalkyl starch derivative of formula (IIa) with a biologically active agent; or
reacting the thiol functionalized hydroxyalkyl starch derivative of formula (IIa) with an at least bifunctional linking compound and reacting the obtained product with a biologically active agent; or
reacting a biologically active agent with an at least bifunctional linking compound and reacting the obtained product with the thiol functionalized hydroxyalkyl starch derivative of formula (IIa); or
reacting the thiol functionalized hydroxyalkyl starch derivative of formula (IIa) with a first at least bifunctional linking compound obtaining a first product, reacting a biologically active agent with a second at least bifunctional linking compound obtaining a second product, and reacting the first with the second product, wherein the thiol functionalized hydroxyalkyl starch derivative of formula (IIa) is obtainable or obtained by the process of the present invention comprising steps (i), (ii) and (iii).

The present invention is illustrated by the following preferred embodiments and the combinations of embodiments according to the respective dependencies:
1. A process for the preparation of a thiol functionalized hydroxyalkyl starch derivative comprising
   (i) providing a reaction mixture comprising a solvent and hydroxyalkyl starch of formula (Ia)

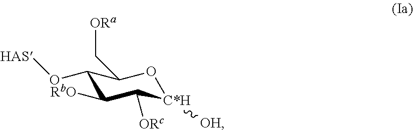

a compound of formula (Ib)

H₂N—CH₂—CH₂—S(—S—CH₂—CH₂—NH)ₓ—H (Ib)
wherein x=0 or 1,
and a reductive amination agent;
(ii) subjecting the reaction mixture provided in (i) to reductive amination conditions, obtaining, optionally after purification, a mixture comprising a thiol functionalized hydroxyalkyl starch derivative of formula (IIa)

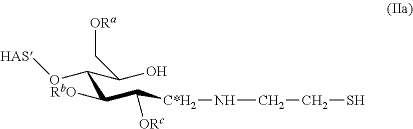

and/or a thiol functionalized hydroxyalkyl starch derivative of formula (IIb)

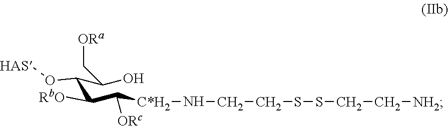

(iii) subjecting the mixture obtained from (ii) to reducing conditions, obtaining, optionally after purification, a mixture comprising the thiol functionalized hydroxyalkyl starch derivative of formula (IIa);
wherein
C* is the carbon atom of the reducing end of the hydroxyalkyl starch;
R^{b} and R^{c} are —[(CR¹R²)ₘO]ₙ—H and are the same or different from each other;
R^{a} is —[(CR¹R²)ₘO]ₙ—H with HAS′ being the remainder of the hydroxyalkyl starch molecule, or R^{a} is HAS″ with HAS′ and HAS″ together being the remainder of the hydroxyalkyl starch molecule;

R¹ and R² are independently hydrogen or an alkyl group having from 1 to 4 carbon atoms,
m is 2 to 4, wherein R¹ and R² are the same or different from each other in the m groups CR¹R²;
n is from 0 to 6.
2. The process of embodiment 1, wherein the hydroxyalkyl starch is hydroxyethyl starch, and wherein R¹ and R² are hydrogen, m is 2, and n is 0 to 6.
3. The process of embodiment 1 or 2, wherein the solvent is a polar solvent, preferably water.
4. The process of any of embodiments 1 to 3, wherein in (i), the compound of formula (Ib) is employed as a salt, preferably as hydrochloride if x is 0 or as dihydrochloride if x=1, the compound preferably being cysteamine.
5. The process of any of embodiments 1 to 4, wherein in (i), the reductive amination agent is sodium cyanoborohydride of formula (Ic)

NaCNBH₄ (Ic).
6. The process of any of embodiments 1 to 5, wherein the reaction mixture provided in (i) comprises the hydroxyalkyl starch at a concentration of at least 1 weight-% mol/l, preferably at least 10 weight-%, more preferably in the range of from 20 to 40 weight-%.
7. The process of any of embodiments 1 to 6, wherein the reaction mixture provided in (i) comprises the compound of formula (Ib) at a at a concentration in the range of from 0.05 to 3 mol/l, preferably from 0.1 to 2.5 mol/l, more preferably from 0.2 to 2 mol/l, more preferably from 0.5 to 2 mol/l.
8. The process of any of embodiments 1 to 7, wherein the reaction mixture provided in (i) comprises the reductive amination agent at a concentration in the range of from 0.05 to 2 mol/l, preferably from 0.1 to 1 mol/l, more preferably from 0.2 to 0.8 mol/l, more preferably from 0.3 to 0.6 mol/l.
9. The process of any of embodiments 1 to 8, wherein the solvent comprised in the reaction mixture provided in (i) does not comprise a buffer.
10. The process of any of embodiments 1 to 9, wherein in (ii), subjecting the reaction mixture provided in (i) to reductive amination conditions comprises keeping the mixture at a temperature in the range of from 40 to 90° C. for a period of from 1 to 36 h, preferably at a temperature in the range of from 45 to 80° C. for a period of from 2 to 24 h, more preferably at a temperature in the range of from 55 to 65° C. for a period of from 4 to 18 h.
11. The process of any of embodiments 1 to 10, wherein (ii) comprises
   (a1) subjecting the reaction mixture provided in (i) to reductive amination conditions;
   (b1) optionally adjusting the pH of the reaction mixture obtained from (a1) to a value of at least 8, preferably at least 9, more preferably from 9 to 11;
   (c1) purifying the mixture obtained from (b1), preferably by ultrafiltration, more preferably by ultrafiltration comprising at least one volume exchange with water.
12. The process of any of embodiments 1 to 11, wherein in (iii), sodium borohydride of formula (Id)

NaBH₄ (Id)
is added as reducing agent to the mixture obtained from (ii) and the mixture obtained from adding the sodium borohydride comprises the sodium borohydride preferably at a concentration in the range of from 0.05 to 1.5 mol/l, more preferably from 0.05 to 1 mol/1 and more preferably from 0.1 to 0.5 mol/l.
13. The process of any of embodiments 1 to 12, wherein in (iii), the mixture comprises the hydroxyalkyl starch and the hydroxyalkyl starch derivative at a concentration in the range of from 5 to 30 weight-%, preferably from 10 to 20 weight-%.
14. The process of any of embodiments 1 to 13, wherein in (iii), subjecting the mixture to reducing conditions comprises keeping the mixture at a temperature in the range of from 10 to 35° C. for a period of from 0.25 to 4 h, more preferably at a temperature in the range of from 20 to 30° C. for a period of from 1 to 3 h.
15. The process of any of embodiments 1 to 14, wherein in (iii), prior to and/or during subjecting the mixture to reducing conditions, at least one anti-foaming agent is added to the mixture.
16. The process of any of embodiments 1 to 15, wherein (iii) comprises
   (a2) subjecting the mixture to reducing conditions;
   (b2) quenching the mixture obtained from (a2), preferably with an acid, preferably selected from the group consisting of acetic acid, hydrochloric acid, sulfuric acid, citric acid, and a mixture of two or more thereof, more preferably with acetic acid, obtaining an acidic solution;
   (c2) purifying the mixture obtained from (b2), preferably by ultrafiltration, more preferably by ultrafiltration comprising at least one volume exchange with an acidic buffer solution optionally comprising an ion chelating agent, and further comprising at least one volume exchange with water;
   (d2) optionally lyophilizing the mixture obtained as retentate from (c2).
17. The process of any of embodiments 1 to 16, wherein the reactive thiol group content of the thiol functionalized hydroxyalkyl starch derivative is at least 50%, preferably at least 70%, more preferably at least 75%, more preferably in the range of from 75 to 90%.
18. A mixture, preferably an aqueous mixture, comprising a thiol functionalized hydroxyalkyl starch derivative of formula (IIa)

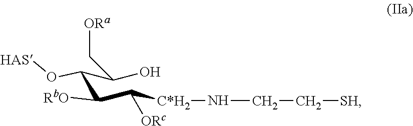

obtainable or obtained by a process according to any of embodiments 1 to 17, preferably by a process comprising
(i) providing an aqueous reaction mixture comprising hydroxyethyl starch of formula (Ia)

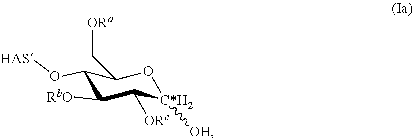

wherein C* is the carbon atom of the reducing end of the hydroxyalkyl starch, HAS′ is the remainder of the hydroxyethyl starch molecule and R^{a}, R^{b} and R^{c} are [(CR¹R²)ₘO]ₙ—H, R^{a}, R^{b} and R^{c} being the same or different from each other wherein R¹ and R² are hydrogen, m is 2, and n is 0 to 6;
the mixture further comprising the hydrochloride of the compound of formula (Ib)

H₂N—CH₂—CH₂—SH (Ib),
and sodium cyanoborohydride of formula (Ic)

NaBH₃CN (Ic);
(ii) (a1) subjecting the reaction mixture provided in (i) to reductive amination conditions;
   (b1) optionally adjusting the pH of the reaction mixture obtained from (a1) to a value from 9 to 11;
   (c1) purifying the mixture obtained from (b1) by ultrafiltration comprising at least one volume exchange with water;
   obtaining a mixture comprising a thiol functionalized hydroxyalkyl starch derivative of formula (IIa)

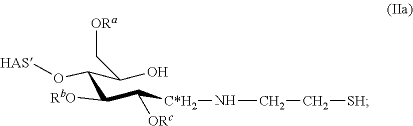

(iii) (a2) subjecting the mixture to reducing conditions at a temperature in the range of from 10 to 35° C. for a period of from 0.25 to 4 h wherein sodium borohydride of formula (Id)

NaBH₄ (Id)
is added as reducing agent to the mixture obtained from (ii);
(b2) quenching the mixture obtained from (a2), preferably with an acid, obtaining an acidic solution;
(c2) purifying the mixture obtained from (b2) by ultrafiltration comprising at least one volume exchange with an acidic buffer solution comprising an ion chelating agent, and further comprising at least one volume exchange with water;
(d2) optionally lyophilizing the mixture obtained as retentate from (c2);
wherein the reactive thiol group content of the thiol functionalized hydroxyalkyl starch derivative is preferably at least 50%, more preferably at least 70%, more preferably at least 75%, more preferably in the range of from 75 to 90%.
19. Use of a thiol functionalized hydroxyalkyl starch derivative of formula (IIa)

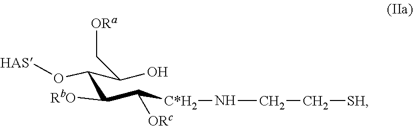

obtainable or obtained by a process according to any of embodiments 1 to 17, for the preparation of a conjugate of hydroxyalkyl starch and a biologically active agent, preferably selected from the group consisting of a peptide, a polypeptide, an enzyme, a small molecule drug, a dye, a lipid, a nucleoside, a nucleotide, a nucleotide analog, an oligonucleotide, a nucleic acid analog, a cell, a virus, a liposome, a microparticle, and a micelle.
20. The use of embodiment 19, wherein the preparation of the conjugate of hydroxyalkyl starch and a biologically active agent comprises
   reacting the thiol functionalized hydroxyalkyl starch derivative of formula (IIa) with a biologically active agent; or
   reacting the thiol functionalized hydroxyalkyl starch derivative of formula (IIa) with an at least bifunctional linking compound and reacting the obtained product with a biologically active agent; or
   reacting a biologically active agent with an at least bifunctional linking compound and reacting the obtained product with the thiol functionalized hydroxyalkyl starch derivative of formula (IIa); or
   reacting the thiol functionalized hydroxyalkyl starch derivative of formula (IIa) with a first at least bifunctional linking compound obtaining a first product,
   reacting a biologically active agent with a second at least bifunctional linking compound obtaining a second product, and reacting the first with the second product.

The present invention is illustrated by the following examples and comparative examples.

### REFERENCE EXAMPLE 1

### Methods

1.1 Determination of the reactive thiol group content

A stock solution of 4 mg/mL of 5,5′-dithio-bis(2-nitrobenzoic acid), Ellman's reagent, in 0.1 M sodium phosphate buffer+1 mM (mmol/l) EDTA (pH 8) buffer was freshly prepared. A 3 mg/mL solution of sample in buffer was prepared and 1 mL of this solution filled into a 2 mL tube. An additional vial containing 1 mL of plain buffer was used as blank. The samples were treated with 100 microL of the reagent stock solution, placed into a mixer and mixed at 750 rpm, 21° C. for 10 minutes. The sample solutions were transferred into plastic cuvettes (d=10 mm) and measured for absorbance at 412 nm. The amount of thiols present in the vial was calculated according to following formula (A=absorbance of sample, A°=absorbance of blank):

$$c [ µmol \text{/} {cm}^{3} ] = \frac{1.1 * ( {A}_{412} - {A}_{412}^{0} )}{14.150 \frac{{cm}^{2}}{µmol} * 1 cm}$$

considering the concentration of 3 mg/mL and 1 cm³=1 mL:

$$Loading [ nmol \text{/} mg ] = \frac{1000 * c}{3 \frac{mg}{mL}}$$

The reactive thiol content was calculated based on the Mₙ [Da] of the test material:

$$RGC [ \% ] = \frac{Loading [ \frac{nmol}{mg} ]}{\frac{{10}^{6}}{Mn} [ \frac{nmol}{mg} ]} * 100$$

The final value was calculated as the average loading from the three samples.

1.2 Determination of the mean molecular weight M_{w}

The “mean molecular weight” as used in the context of the present invention relates to the weight as determined according to MALLS-GPC. For the determination, 2 Tosoh BioSep GMPWXL columns connected in line (13 micrometer particle size, diameter 7.8 mm, length 30 cm, art. no. 08025) were used as stationary phase. The mobile phase was prepared as follows: In a volumetric flask 3.74 g sodium acetate*3H₂O, 0.344 g NaN₃ are dissolved in 800 ml Milli-Q water and 6.9 ml acetic acid anhydride are added and the flask filled up to 1 1. Approximately 10 mg of the respective hydroxyalkyl starch derivative were dissolved in 1 ml of the mobile phase and particle filtrated with a syringe filter (0.22 mm, mStarII, CoStar Cambridge, Mass.). The measurement was carried out at a flow rate of 0.5 ml/min. As detectors a multiple-angle laser light scattering detector and a refractometer maintained at a constant temperature, connected in series, were used.

Astra software (vers. 5.3.4.14, Wyatt Technology Cooperation) was used to determine the mean M_{w} and the mean Mₙ of the sample using a dn/dc of 0.147. The value was determined at 1=690 nm (solvent sodium acetate/H₂O/0.02% NaN₃, T=20° C.) in accordance to the following literature: W. M. Kulicke, U. Kaiser, D. Schwengers, R. Lemmes, Starch, Vol. 43, Issue 10 (1991), 392-396.

### 1.3 Other Methods

Ultrafiltration was performed using a Sartoflow Slice 200 Benchtop (Sartorius AG) equipped with two Hydrosart Membrane cassettes (the membrane cutoff was adjusted to the specific HES size, e.g. 10 kDa cutoff, Sartorius). Pressure settings: p1=2 bar, p2=0.5 bar.

Filtration: Solutions were filtered prior to size exclusion chromatography and HPLC using syringe filters (0.45 micrometer, GHP-Acrodisc, 13 mm) or Steriflip (0.45 micrometer, Millipore).

Size exclusion chromatography was performed using an Äkta Purifier (GE-Healthcare) system equipped with a P-900 pump, a P-960 sample pump using an UV-900 UV detector and a pH/IC-900 conductivity detector. A HiPrep 26/10 desalting column (53 mL, GE-Healthcare) was used together with a HiTrap desalting column as pre-column (5 mL, GE-Healthcare). Fractions were collected using the Frac-902 fraction collector.

Freeze-drying: Samples were frozen in liquid nitrogen and lyophilized using a Christ alpha 1-2 LD plus (Martin Christ, Germany) at p=0.2 mbar.

UV-Vis absorbances were measured at a Cary 100 BIO (Varian) in either plastic cuvettes (PMMA, d=10 mm) or quartz cuvettes (d=10 mm, Hellma, Suprasil, 100-QS) using the Cary Win UV simple reads software.

### REFERENCE EXAMPLE 2

### Materials

The materials according to the following Table 1 were used in the examples and comparative examples of the present invention:

TABLE 1
Relevant materials used

| Entry | Name | Supplier | Lot # | M_{w}/Mₙ |
|---|---|---|---|---|
| 1 | HES 18/0.4 | Fresenius Kabi | 2540SR2.5 | 9.21 kDa/3.58 kDa |
| 2 | HES 100/1.0 | Fresenius Kabi | 17110421 | 93.02 kDa/64.81 kDa |
| | | Linz | | |
| 3 | HES 100/1.0 | Fresenius Kabi | 20120612 | 91.47 kDa/61.63 kDa |
| 4 | HES 100/1.0 | Fresenius Kabi | 17110523-01 | 91.73 kDa/65.48 kDa |
| | | Linz | | |
| 5 | Cysteamine | Fluka | 1442297V | 113.6 Da |
| | hydrochloride, 97% | | | |
| 6 | Cystamine | Sigma-Aldrich | BCBF1386V | 224.2 Da |
| | dihydrochloride, 96% | | | |
| 7 | Na cyanoborohydride | Merck | S6053153 | 62.84 Da |
| | (synth. grade) | | | |
| 8 | Na borohydride | Merck | S6177873 | 37.1 Da |

### Comparative Example 1

### Preparation of a Thiol Functionalized HES According to the Prior Art

A monothiol functionalized HES derivative was prepared as disclosed in example 13.4 a) and in example 13.4 b) of EP 1 398 322 A1. As described, cysteamine free base was employed. In addition to HES 18/0.4 (M_{w}=18 kDa, DS=0.4), HES 100/1.0 (Lot. 20120612) was employed as starting material, and the reaction conditions as taught in example 13.4 a) and in example 13.4 b) of EP 1 398 322 A1 were applied. The concentration of the cysteamine free base was 0.177 mol/l, the concentration of the sodium cyanoborohydride was 0.159 mol/l, and the concentration of the HES was 40 mg/ml in each experiment.

The reactive thiol group content was determined as described in Reference Example 1 above. The following results are shown in Table 1 below.

### Example 1

### Preparation of a Thiol Functionalized HES

Based on thiol functionalized HES derivatives obtained according to the teaching of the prior art as described in comparative example 1 above, aqueous solutions were prepared having a HES derivative concentration of 2 weight-%. Sodium borohydride was added in an amount so that the solution had a sodium borohydride concentration 0.11 mol/l. The resulting mixture was stirred for 2 h at room temperature. The reduction reaction mixture was quenched by careful addition of acetic acid and the pH was adjusted to a value of less than 5. The mixture was purified by ultrafiltration (15 volume exchanges with 10 mM acetate buffer+5 mM EDTA, pH 4, followed by 5 volume exchanges with water). The retentate was freeze-dried to give a colorless foamy solid.

The reactive thiol group content was determined as described in Reference Example 1 above. The following results are shown in Table 2 below.

TABLE 2
Results of Comparative Example 1 and Example 1

| | reductive amination | | reductive amination | |
|---|---|---|---|---|
| | at 80° C. for 17 h | | at 25° C. for 3 d | |
| | without | with | without | with |
| | reducing step | reducing step | reducing step | reducing step |
| | degree of derivatization/% | | | |
| HES 18/0.4 | 4 | 37 | 9 | 47 |
| HES 100/1.0 | 8 | 47 | 2 | 15 |
| | M_{w} increase/% | | | |
| HES 100/1.0 | +19 | +7 | +1 | +1 |

Clearly, the reducing step carried out according to example 1 led to a significantly increased reactive thiol group content, compared to the prior art process described in comparative example 1 above according to which only the reductive amination step was carried out. Regardless which reaction conditions were applied in the reductive amination step, the subsequent reducing step led to an increase in the reactive thiol group content of about 400 to 800%.

### Example 2

### Preparation of a Thiol Functionalized HES with Cystamine Dihydrochloride

A 100 mL round flask equipped with a magnetic stirrer, rubber septum and electrical heating was charged with 10 g HES 100/1.0 (Lot. 17110421). 20 mL of purified water were added, and the HES was dissolved under stirring at 60° C. resulting in a total volume of about 30 mL. After formation of a homogenous solution, cystamine dihydrochloride was added and dissolved followed by addition of sodium cyanoborohydride. In the resulting mixture, the HES concentration was 300 mg/mL, the cystamine concentration was 1 mol/l, and the sodium cyanoborohydride concentration was 0.6 mol/l. The mixture was stirred overnight (16-18 h) at 60° C. After finishing of the reductive amination, the pH of the reaction mixture was adjusted to a value of above 9 by addition of 8 M NaOH. The mixture was diluted to a HES concentration of about 10 mg/mL and purified by ultrafiltration (Sartorius Sartoflow Slice 200 Benchtop, 2×10 kDa Hydrosart Membranes, 15-20 volume exchanges with water).

The retentate (100 mL) was transferred into a 250 mL flask equipped with magnetic stirring and a rubber septum under inert gas. 1 g of sodium borohydride was added. The mixture obtained had a sodium borohydride concentration of 0.6 mol/1 and a HES concentration 10 weight-%. The mixture was stirred at room temperature for 2 h. The reduction was quenched by careful addition of acetic acid and the pH was adjusted to a value of less than 5. The mixture was purified by ultrafiltration (15 volume exchanges with 10 mM acetate buffer+5 mM EDTA, pH 4, followed by 5 volume exchanges with water). The retentate was freeze-dried to give a colorless foamy solid.

The reactive thiol group content, as determined as described in Reference Example 1 above, was 57%. The increase of the molecular weight M_{w} was ±0%.

Therefore, compared to the results of example 1, it is shown that at the preferred reductive amination reaction conditions according to example 2 compared to the reductive amination reaction conditions as taught in the prior art and at identical reducing conditions in the reducing reaction, the process of the invention shows even more advantageous reactive thiol group content (57% compared to 47% for HES 100/1.0, the best value according to example 1).

### Example 3

### Preparation of a Thiol Functionalized HES with Cysteamine Hydrochloride

Example 3 was carried out as example 3, wherein for the reductive amination, cysteamine hydrochloride was used instead of cystamine dihydrochloride. In the resulting reductive amination mixture, the HES concentration was 300 mg/mL, the cysteamine concentration was 2 mol/l, and the sodium cyanoborohydride concentration was 0.6 mol/l.

The reactive thiol group content, as determined as described in Reference Example 1 above, was 85%. The molecular weight M_{w} was 1% lower than the molecular weight of the HES starting material.

Therefore, although according to example 3, cysteamine was employed as reductive amination agent lacking the —S—S— moiety compared to the cystamine used in example 2, it was surprisingly found that subjecting the reaction mixture obtained from reductive amination significantly improves the reactive thiol group content from 57% to 85%. In particular, compared to the results of example 2, it is shown that at the especially preferred reductive amination reaction conditions according to example 3 wherein compared to the reductive amination reaction conditions according to example 2, cysteamine hydrochloride is used as reductive amination agent instead of cystamine dihydrochloride, and at identical reducing conditions in the reducing reaction, the process of the invention shows said even more advantageous reactive thiol group content.

### Comparative Example 2

### Preparation of a Thiol Functionalized HES

According to A. Pawlowski et al., Vaccine 17 (1999) pp 1474-1483, in particular according to section 2.6 of this article, the teaching of this document regarding dextran was tried to transfer to the derivatization of hydroxyethyl starch. Therefore, the two-stage reductive amination reaction according to A. Pawlowski et al. was repeated according to which in a first step, the pH of the reaction mixture has to be adjusted to a value of 8.3 using a buffer, and, after having added the reductive amination agent, the pH has to be adjusted to a value of 7.5 by adding sodium hydroxide. Only after the adjustment to the second pH value, the resulting mixture is subjected to reductive amination conditions. As far as the reducing step is concerned, A. Pawlowski et al. only teaches that it can be carried out using sodium borohydride; however, no reducing conditions are given. Hence, although for a conceivable reducing reaction, no parameters are given in A. Pawlowski et al., the preferred reducing conditions were applied, in accordance with examples 1, 2 and 3 of the present invention. Thus, strictly speaking, this example is not a comparative example since regarding the reducing reaction, the preferred reducing conditions, not even mentioned in the prior art and found by the inventors in the context of the present invention, were applied.

The reductive amination reaction was carried out as described in section 2.6 of A. Pawlowski et al., using cystamine dihydrochloride as reductive amination agent and HES 100/1.0 (Lot. 20120612) instead of dextran. Since in A. Pawlowski et al., a range for the molar excess of the reductive amination agent of from 5 to 150 is disclosed, two representative excess values were chosen, namely a 20-fold and a 150-fold excess. The reduction reaction was carried out as described in examples 1 to 3 of the present invention. The reactive thiol group content was determined as described in Reference Example 1 above. For a 20-fold excess of the reductive amination agent relative to the HES, a reactive thiol group content of 11% was found, whereas for a 150-fold excess of the reductive amination agent relative to the HES, a reactive thiol group content of 36% was found. The increase of the molecular weight M_{w} for the 20-fold excess and the 150-fold excess were found to be +2% and +7%, respectively.

Therefore, although the preferred reducing reaction was carried out which is not described at all in A. Pawlowski et al., even the most preferred excess, the 150-fold excess, results in a reactive thiol group content of 36% which is lower than the respective reactive thiol group content of example 1 (37%) where, as far as the reductive amination reaction is concerned, the prior art teaching of EP 1 398 322 A1 was repeated. Consequently, it could be shown that even if the two-step reductive amination process of A. Pawlowski et al. is carried out in combination with the preferred reducing reaction according to the present invention, the result in terms of the reactive thiol group content is disadvantageous compared to a one-step reductive amination process, even if this one-step reductive amination process is not carried out according to the preferred conditions according to the present invention.

### Example 4

### Preparation of a Thiol Functionalized HES without Buffer and Cysteamine Hydrochloride (Scale-Up)

A 5 L glass reactor with temperature control and mechanical stirrer (Sartorius) was charged with 1400 mL of water and 613 g of HES 100/1.0 (Lot. 17110523-01). The HES was dissolved under vigorous stirring at 60° C. for 2.5 h resulting in about 2 L of clear, viscous solution. 231 g (2.03 mol=about 1 mol/l) of cysteamine hydrochloride were added, followed by 38.5 g (0.61 mol, about 0.3 mol/l) of sodium cyanoborohydride. The reagent dissolved under foaming. The mixture was stirred at 60° C. for 18 h. The reaction mixture was then cooled to room temperature and alkalized with 30 mL of 6 M NaOH to a pH of above 9. The mixture was then subjected to ultrafiltration (Centramate 500S, Pall Corporation with 10 kDa Hydrosart membranes, Sartorius) with 15 volume exchanges against water. The retentate was stored in the freezer overnight, then transferred back to the reactor for final reduction.

To the aqueous solution obtained from the reductive amination reaction (3.5 L), 34 g of sodium borohydride (about 1 mg/ml) were added in portions under constant stirring. In order to inhibit the formation of a thick foam, 30 mL of ethanol were added. The reaction was allowed to stir for 2 h at room temperature. Residual borohydride was quenched by careful addition of acetic acid (about 50 mL over 20 min) until cessation of foam formation. The solution (about 4 L) was purified by ultrafiltration with 19 volume exchanges of a 10 mM acetate buffer (pH 4) containing 1 mM EDTA, followed by additional 5 volume exchanges with purified water. The retentate was lyophilized.

The reactive thiol group content, as determined as described in Reference Example 1 above, was 81%.

### CITED PRIOR ART

EP 1 398 322 A1
A. Pawlowski et al., Vaccine 17 (1999) pp 1474-1483
P. Babu et al., Bioconjugate Chem. 18 (2007) pp 146-151
Sommermeyer et al., Krankenhauspharmazie, 8(8) (1987) pp 271-278
Ying-Che Lee et al., Anal. Chem. 55 (1983) pp 334-338
K. L. Hodges et al., Anal. Chem. 51 (1979) p 2171
W. M. Kulicke et al., Starch, 43(10) (1991) pp 392-396

1-20. (canceled)

21. A process for the preparation of a thiol functionalized hydroxyalkyl starch derivative comprising:
(i) providing a reaction mixture comprising a solvent and hydroxyalkyl starch of formula (Ia) 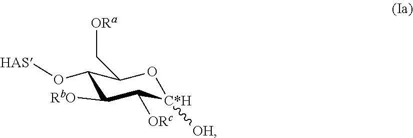
a compound of formula (Ib)
H₂N—CH₂—CH₂—S(—S—CH₂—CH₂—NH)ₓ—H (Ib)
wherein x=0 or 1,
and a reductive amination agent;
(ii) subjecting the reaction mixture provided in (i) to reductive amination conditions, obtaining, optionally after purification, a mixture comprising a thiol functionalized hydroxyalkyl starch derivative of formula (IIa) 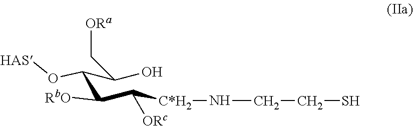
and/or a thiol functionalized hydroxyalkyl starch derivative of formula (IIb) 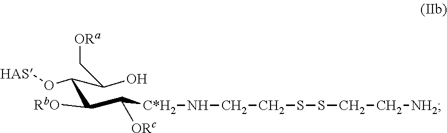
(iii) subjecting the mixture obtained from (ii) to reducing conditions, obtaining, optionally after purification, a mixture comprising the thiol functionalized hydroxyalkyl starch derivative of formula (IIa);
wherein
C* is the carbon atom of the reducing end of the hydroxyalkyl starch;
R^{b} and R^{c} are —[(CR¹R²)ₘO]ₙ—H and are the same or different from each other;
R^{a} is —[(CR¹R²)ₘO]ₙ—H with HAS′ being the remainder of the hydroxyalkyl starch molecule, or R^{a} is HAS″ with HAS′ and HAS″ together being the remainder of the hydroxyalkyl starch molecule;
R¹ and R² are independently hydrogen or an alkyl group having from 1 to 4 carbon atoms,
m is 2 to 4, wherein R¹ and R² are the same or different from each other in the m groups CR¹R²;
n is from 0 to 6.

22. The process of claim 21, wherein the hydroxyalkyl starch is hydroxyethyl starch, and wherein R¹ and R² are hydrogen, m is 2, and n is 0 to 6.

23. The process of claim 21, wherein the solvent is a polar solvent.

24. The process of claim 21, wherein in (i), the compound of formula (Ib) is employed as a salt.

25. The process of claim 21, wherein in (i), the reductive amination agent is sodium cyanoborohydride of formula (Ic)
NaCNBH₄ (Ic).

26. The process of claim 21, wherein the reaction mixture provided in (i) comprises the hydroxyalkyl starch at a concentration of at least 1 weight-% mol/l.

27. The process of claim 21, wherein the reaction mixture provided in (i) comprises the compound of formula (Ib) at a at a concentration in the range of from 0.05 to 3 mol/l.

28. The process of claim 21, wherein the reaction mixture provided in (i) comprises the reductive amination agent at a concentration in the range of from 0.05 to 2 mol/l.

29. The process of claim 21, wherein the solvent comprised in the reaction mixture provided in (i) does not comprise a buffer.

30. The process of claim 21, wherein in (ii), subjecting the reaction mixture provided in (i) to reductive amination conditions comprises keeping the mixture at a temperature in the range of from 40 to 90° C. for a period of from 1 to 36 h.

31. The process of claim 21, wherein (ii) comprises:
(a1) subjecting the reaction mixture provided in (i) to reductive amination conditions;
(b1) optionally adjusting the pH of the reaction mixture obtained from (a1) to a value of at least 8;
(c1) purifying the mixture obtained from (b1).

32. The process of claim 21, wherein in (iii), sodium borohydride of formula (Id)
NaBH₄ (Id)
is added as reducing agent to the mixture obtained from (ii) and the mixture obtained from adding the sodium borohydride comprises the sodium borohydride.

33. The process of claim 21, wherein in (iii), the mixture comprises the hydroxyalkyl starch and the hydroxyalkyl starch derivative at a concentration in the range of from 5 to 30 weight-%.

34. The process of claim 21, wherein in (iii), subjecting the mixture to reducing conditions comprises keeping the mixture at a temperature in the range of from 10 to 35° C. for a period of from 0.25 to 4 h.

35. The process of claim 21, wherein in (iii), prior to and/or during subjecting the mixture to reducing conditions, at least one anti-foaming agent is added to the mixture.

36. The process of claim 21, wherein (iii) comprises:
(a2) subjecting the mixture to reducing conditions;
(b2) quenching the mixture obtained from (a2) with an acid, obtaining an acidic solution;
(c2) purifying the mixture obtained from (b2);
(d2) optionally lyophilizing the mixture obtained as retentate from (c2).

37. The process of claim 21, wherein the reactive thiol group content of the thiol functionalized hydroxyalkyl starch derivative is at least 50%.

38. A mixture, comprising a thiol functionalized hydroxyalkyl starch derivative of formula (IIa) 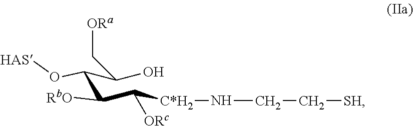
obtainable or obtained by a process according to claim 21.

39. Use of a thiol functionalized hydroxyalkyl starch derivative of formula (IIa) 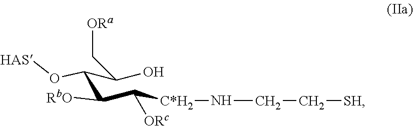
obtainable or obtained by a process according to claim 21, for the preparation of a conjugate of hydroxyalkyl starch and a biologically active agent selected from the group consisting of a peptide, a polypeptide, an enzyme, a small molecule drug, a dye, a lipid, a nucleoside, a nucleotide, a nucleotide analog, an oligonucleotide, a nucleic acid analog, a cell, a virus, a liposome, a microparticle, and a micelle.

40. The use of claim 39, wherein the preparation of the conjugate of hydroxyalkyl starch and a biologically active agent comprises:
reacting the thiol functionalized hydroxyalkyl starch derivative of formula (IIa) with a biologically active agent; or
reacting the thiol functionalized hydroxyalkyl starch derivative of formula (IIa) with an at least bifunctional linking compound and reacting the obtained product with a biologically active agent; or
reacting a biologically active agent with an at least bifunctional linking compound and reacting the obtained product with the thiol functionalized hydroxyalkyl starch derivative of formula (IIa); or
reacting the thiol functionalized hydroxyalkyl starch derivative of formula (IIa) with a first at least bifunctional linking compound obtaining a first product, reacting a biologically active agent with a second at least bifunctional linking compound obtaining a second product, and reacting the first with the second product.
